(19) United States
(12) Patent Application Publication
(10) Pub. No.: US 2016/0261051 A1
(43) Pub. Date: Sep. 8, 2016

(54) MONOPOLE ANTENNA

(71) Applicant: Arcadyan Technology Corporation, Hsinchu City (TW)

(72) Inventors: Min-Chi WU, Zhubei City (TW); Kuo-Chang LO, Miaoli County (TW); Chih-Yung HUANG, Taichung City (TW)

(73) Assignee: Arcadyan Technology Corporation, Hsinchu City (TW)

(21) Appl. No.: 15/061,668

(22) Filed: Mar. 4, 2016

(30) Foreign Application Priority Data
Mar. 5, 2015 (TW) 104107004

(51) Int. Cl. H01Q 21/30; H01Q 1/38; H01Q 5/10

(52) U.S. Cl. CPC H01Q 21/30; H01Q 5/10; H01Q 1/38

(57) ABSTRACT

A monopole antenna including a ground plane and a radiation body is provided. The radiation body includes a feeding connection part, a first radiation part, a second radiation part and a third radiation part. The feeding connection part is adjacent to the ground plane. The first radiation part connects one side of the feeding connection part and extends along a first direction. The first radiation part includes a metal patch whose width reduces towards the first direction. The second radiation part, being closer to the ground plane than the first radiation part, connects the side of the feeding connection part and extends along the first direction. The third radiation part connects the other side of the feeding connection part and extends along a second direction inverse to the first direction.

This application claims the benefit of Taiwan application Serial No. 104107004, filed Mar. 5, 2015, the disclosure of which is incorporated by reference herein in its entirety.

### TECHNICAL FIELD

The disclosure relates in general to an antenna, and more particularly to a multi-band monopole antenna.

### BACKGROUND

Along with the development in the communication technology, wireless communication devices, such as notebook computers, mobile phones, and wireless access points (AP), normally are capable of operating in different bands. In response to the requirements of performing wireless data transmission in different bands, conventionally radio frequency (RF) front-end elements of the device are implemented by broad-band antennas or multi-band antennas.

However, the conventional design of multi-band antenna is hard to be adapted to different operating bands, and is restricted to low frequency bands.

Therefore, how to provide an adaptable multi-band antenna having excellent antenna properties has become a prominent task for the industries.

### SUMMARY

The disclosure is directed to a multi-band monopole antenna.

According to one embodiment of the present invention, a monopole antenna is provided. The monopole antenna is printed on a substrate and includes a ground plane and a radiation body. The radiation body includes a feeding connection part, a first radiation part, a second radiation part and a third radiation part. The feeding connection part is adjacent to the ground plane. The first radiation part, which connects one side of the feeding connection part and extends along a first direction, is in charge of a first operating frequency of the monopole antenna. The first radiation part includes a metal patch whose width reduces towards the first direction. The second radiation part, which connects the side of the feeding connection part and extends along the first direction, is closer to the ground plane than the first radiation part and is in charge of a second operating frequency of the monopole antenna. The third radiation part, which connects the other side of the feeding connection part and extends along a second direction inverse to the first direction, is in charge of a third operating frequency of the monopole antenna. The second operating frequency is higher than the third operating frequency, and the third operating frequency is higher than the first operating frequency.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a monopole antenna according to an embodiment of the present invention.

FIG. 2A is a schematic diagram of a current path of a radiation body under a first radiation frequency according to an embodiment of the present invention.

FIG. 2B is a schematic diagram of a current path of a radiation body under a second radiation frequency according to an embodiment of the present invention.

FIG. 2C is a schematic diagram of a current path of a radiation body under a third radiation frequency according to an embodiment of the present invention.

FIG. 3A is a schematic diagram of a radiation unit according to another embodiment of the present invention.

FIG. 3B is a schematic diagram of a radiation unit according to an alternate embodiment of the present invention.

FIG. 4A is a schematic diagram of a radiation unit according to an alternate of the present invention.

FIG. 4B is a schematic diagram of a radiation unit according to an alternate of the present invention.

FIG. 5A is a side view of a monopole antenna according to an embodiment of the present invention.

FIG. 5B is a side view of a monopole antenna according to another embodiment of the present invention.

FIG. 6 is a measurement chart of reflection coefficient of a monopole antenna according to an embodiment of the present invention.

FIG. 7 is a simulation chart of radiation efficiency of a monopole antenna according to an embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A number of embodiments are disclosed below for elaborating the invention. However, the embodiments of the invention are for detailed descriptions only, not for limiting the scope of protection of the present disclosure. Furthermore, secondary or unimportant elements are omitted in the accompanying diagrams of the embodiments for highlighting the technical features of the present disclosure.

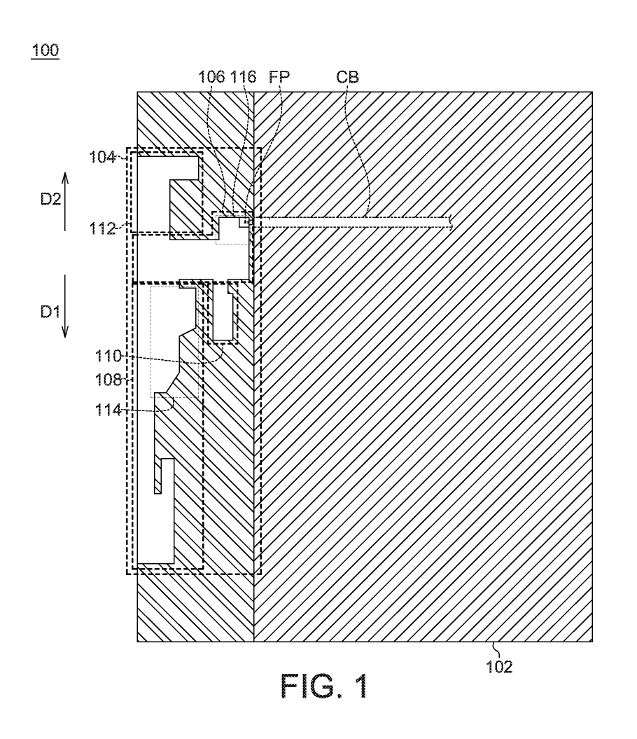

Referring to FIG. 1, a schematic diagram of a monopole antenna 100 according to an embodiment of the present invention is shown. As indicated in FIG. 1, the monopole antenna 100 includes a ground plane 102 and a radiation body 104. The monopole antenna 100 is printed on a substrate. The radiation body 104 and the ground plane 102 can be disposed on the same side surface or two side surfaces of the substrate. In general, to avoid the properties of the monopole antenna 100 being jeopardized, no other metal patterns or elements are disposed within the substrate region on which the projection of the radiation body 104 falls.

The radiation body 104 includes a feeding connection part 106, a first radiation part 108, a second radiation part 110 and a third radiation part 112. The feeding connection part 106 is adjacent to the ground plane 102, but is not directly connected to the ground plane 102. In an embodiment, one end of the feeding connection part 106 adjacent to the ground plane 102 includes a signal feeding region 116 extending towards the direction D2 for receiving RF signals. For example, a cable CB of 50 ohms can be soldered at a feed point FP of the signal feeding region 116 such that the RF signals can be directly fed to the monopole antenna 100 through the cable. For example, the cable is soldered at a top right corner of the signal feeding region 116. However, the present invention is not limited to the said exemplification. The monopole antenna 100 can receive RF signals through a transmission line printed on the substrate or through other generally known signal transmission elements. In the present embodiment, by disposing the signal feeding region 116 extending towards the direction D2 on the feeding connection part 106, the impedance matching of the monopole antenna 100 is effectively improved.

The first radiation part 108 connects a first side of the feeding connection part 106 and extends along the direction D1 (towards the bottom of FIG. 1). The first radiation part 108 is mainly in charge of a first operating frequency of the monopole antenna 100. In an embodiment, of the many operating frequencies excited by the monopole antenna 100, the first operating frequency is relatively lower. By adjusting the length of the first radiation part 108, the position of the first operating frequency can be correspondingly adjusted. In general, the length from the feed point FP to the terminal end of the first radiation part 108 is approximately equivalent to ¼ wavelength of the first operating frequency.

In an embodiment, the overall antenna size can be reduced through the bending design of the first radiation part 108. As indicated in FIG. 1, the terminal end of the first radiation part 108 is bent upwards towards the ground plane 102 (direction D2). It is understood that the first radiation part 108 can have other bending design to increase the overall current path and reduce the overall antenna size.

The first radiation part 108 includes a metal patch 114. The length by which the metal patch 114 extends towards the direction D1 is smaller than the length by which the first radiation part 108 extends towards the direction D1. The metal patch 114 is adjacent to the first side of the feeding connection part 106 but farther away from the terminal end of the first radiation part 108 extending towards the direction D1. As indicated in FIG. 1, the width of the metal patch 114 reduces towards the direction D1, and the length of the metal patch 114 is larger than that of the second radiation part 110. Through the above disposition, the current path towards the first radiation part 108 can be increased, and the operating band of the antenna can be increased accordingly. The metal patch 114 can also be used to adjust the impedance matching of the monopole antenna 100, such that the monopole antenna 100 has lower return loss.

The second radiation part 110 connects the first side of the feeding connection part 106 and is closer to the ground plane 102 than the first radiation part 108. That is, the second radiation part 110 and the first radiation part 108 both connect to the same side of the feeding connection part 106. The second radiation part 110, which extends along the direction D1, is in charge of a second operating frequency of the monopole antenna 100. In an embodiment, of the many operating frequencies excited by the monopole antenna 100, the second operating frequency is relatively higher. By adjusting the length of the second radiation part 110, the position of the second operating frequency can be correspondingly adjusted. In general, the length from the feed point FP to the terminal end of the second radiation part 110 is approximately equivalent to ¼ wavelength of the second operating frequency.

In an embodiment, the width of the second radiation part 110 increases towards the direction D1. As indicated in FIG. 1, the width of the second radiation part 110 at the front end (the junction with the feeding connection part 106) is smaller than that at the middle end or at the terminal end. In the present embodiment, the width increase of the second radiation part 110 towards the direction D1 not only effectively increases the bandwidth of the second operating frequency of the monopole antenna 100 but further compensates the capacitance and inductance effects of the second radiation part 110 with respect to the ground plane 102 and improves the impedance matching of the antenna.

The third radiation part 112 connects a second side of the feeding connection part 106. The second side and the first side are disposed oppositely. That is, the side of the feeding connection part 106 on which the third radiation part 112 is disposed is different from the side of the feeding connection part 106 on which the first radiation part 108 and the second radiation part 110 are disposed. As indicated in FIG. 1, the third radiation part 112 extends along a direction D2 inverse to the direction D1. In an embodiment, the first radiation part 108 and the third radiation part 112 connect the feeding connection part 106 by the other end of the feeding connection part 106 farther away from the ground plane 102, such that the feeding connection part 106, the first radiation part 108 and the third radiation part 112 form a T shape. The first radiation part 108 and the third radiation part 112 are perpendicular to the feeding connection part 106. The first radiation part 108 and the third radiation part 112 are inversely disposed by 180°.

The third radiation part 112 is in charge of a third operating frequency of the monopole antenna 100. In an embodiment, of the many operating frequencies excited by the monopole antenna 100, the third operating frequency is relatively medium. By adjusting the length of the third radiation part 112, the position of the second operating frequency can be correspondingly adjusted. In general, the length from the feed point FP to the terminal end of the third radiation part 112 is approximately equivalent to ¼ wavelength of the third operating frequency.

In an embodiment, the overall antenna size can be reduced through the bending design of the third radiation part 112. As indicated in FIG. 1, the terminal end of the third radiation part 112 is bent upwards towards the ground plane 102 (direction D2). It is understood that the third radiation part 112 can have other bending design to increase the overall current path and reduce the overall antenna size.

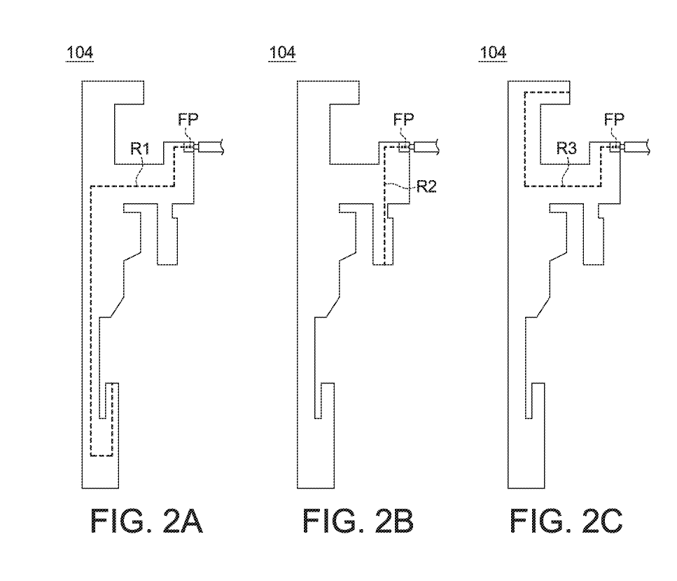

Refer to FIGS. 2A, 2B, 2C. FIG. 2A is a schematic diagram of a current path R1 of a radiation body DL 104 under a first radiation frequency according to an embodiment of the present invention. FIG. 2B is a schematic diagram of a current path R2 of a radiation body 104 under a second radiation frequency according to an embodiment of the present invention. FIG. 2C is a schematic diagram of a current path R3 of a radiation body 104 under a third radiation frequency according to an embodiment of the present invention.

As disclosed above, since the first radiation part 108 mainly excites the radiation mode of the monopole antenna 100 under the first operating frequency, the length of the current path R1 from the feed point FP to the terminal end of the first radiation part 108 is approximately equivalent to ¼ wavelength of the first operating frequency. Similarly, since the second radiation part 110 mainly excites the radiation mode of the monopole antenna 100 under the second operating frequency, the length of the current path R2 from the feed point FP to the terminal end of the second radiation part 110 is approximately equivalent to ¼ wavelength of the second operating frequency. Similarly, since the third radiation part 112 mainly excites the radiation mode of the monopole antenna 100 under the third operating frequency, the length of the current path R3 from the feed point FP to the terminal end of the third radiation part 112 is approximately equivalent to ¼ wavelength of the third operating frequency. In the present embodiment, the second operating frequency is higher than the third operating frequency, and the third operating frequency is higher than the first operating frequency. Therefore, the current path R1 has the largest length, the current path R3 comes second, and the current path R2 has the smallest length.

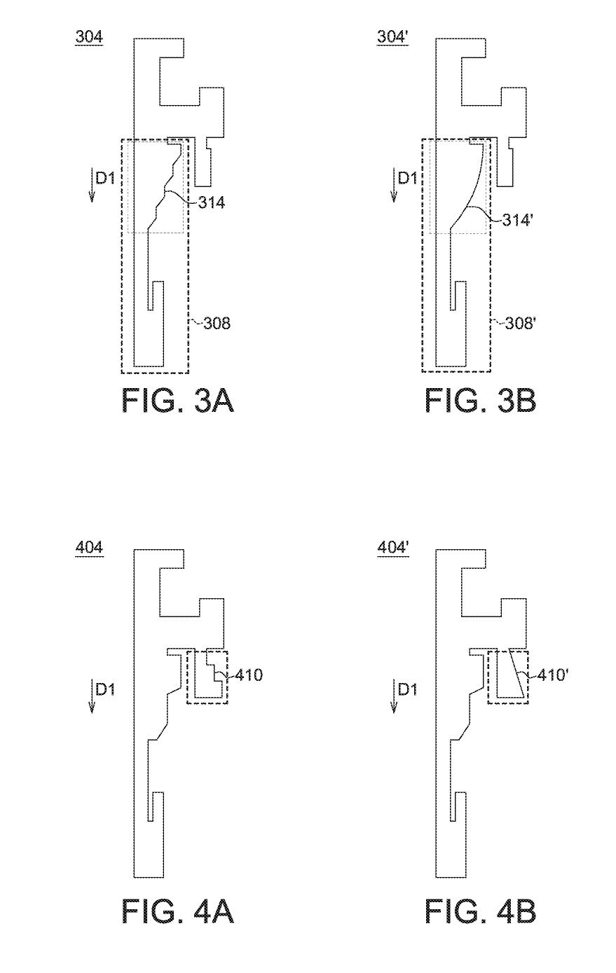

FIG. 3A is a schematic diagram of a radiation unit 304 according to another embodiment of the present invention. The radiation unit 304 is different from the radiation unit 104 of FIG. 1 mainly in that the width of the metal patch 314 of the first radiation part 308 reduces towards the direction D1 in N steps, wherein N is a positive integer greater than 2. As indicated in FIG. 3A, the width of the metal patch 314 reduces towards the direction D1 in 4 steps. As indicated in FIG. 1, the width of the metal patch 114 reduces towards the direction D1 in 2 steps. However, the present invention is not limited to the above exemplifications. Any designs allowing the width of the metal patch of the first radiation part of the radiation unit to gradually reduce towards the direction D1 in a stepped manner are within the spirit of the present invention.

FIG. 3B is a schematic diagram of a radiation unit 304′ according to an alternate embodiment of the present invention. The radiation unit 304′ of FIG. 3B is different from the radiation unit 104 of FIG. 1 mainly in that the width of the metal patch 304′ of the first radiation part 308′ gradually reduces towards the direction D1 in a smooth manner. As indicated in FIG. 3B, one side of the metal patch 304′ is a smooth curve having a radian. In another embodiment, one side of the metal patch 304′ can be a slanted straight line.

FIG. 4A is a schematic diagram of a radiation unit 404 according to an alternate of the present invention. The radiation unit 404 of FIG. 4A is different from the radiation unit 104 of FIG. 1 mainly in that the width of the second radiation part 410 increases towards the direction D1 in M steps, wherein M is a positive integer greater than 1. As indicated in FIG. 4A, the width of the second radiation part 410 increases towards the direction D1 in 3 steps. The width of the second radiation part 110 of FIG. 1 increases towards the direction D1 in 2 steps. However, the present invention is not limited to the above exemplifications. Any designs allowing the width of the second radiation part of the radiation unit to gradually increase towards the direction D1 in a stepped manner are within the spirit of the present invention.

FIG. 4B is a schematic diagram of a radiation unit 404′ according to an alternate of the present invention. The radiation unit 404′ of FIG. 4B is different from the radiation unit 104 of FIG. 1 mainly in that the width of the second radiation part 410 increases towards the direction D1 in a smooth manner. As indicated in FIG. 4B, one side of the second radiation part 410 is a slanted straight line. In another embodiment, one side of the second radiation part 410 is a smooth curve having a radian.

It can be understood that the monopole antenna generated by integrating and modifying the above embodiments is also within the spirit of the present invention. For example, the metal patch 114 of the monopole antenna 100 can be replaced by the metal patch 314 of FIG. 3A or the metal patch 314′ of FIG. 3B, and the second radiation part 110 can be replaced by the second radiation part 410 of FIG. 4A or the second radiation part 410′ of FIG. 4B.

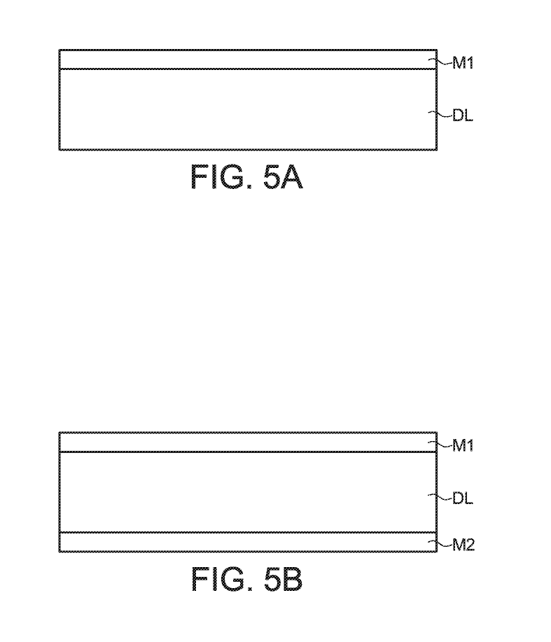

Refer to FIG. 5A and FIG. 5B. FIG. 5A is a side view of a monopole antenna according to an embodiment of the present invention. FIG. 5B is a side view of a monopole antenna according to another embodiment of the present invention.

The monopole antenna disclosed in above embodiments of the present invention is printed on a substrate, and the radiation body and the ground plane can be disposed on the same side surface or two side surfaces of the substrate. FIG. 5A illustrate a double-layer structure, wherein the radiation body of the monopole antenna is printed on the metal layer M1, and the dielectric layer DL is disposed under the metal layer M1. FIG. 5B is a triple-layer structure, wherein the radiation body of the monopole antenna is printed on the metal layer M1, the ground plane is printed on the metal layer M2, and the dielectric layer DL is interposed between the metal layer M1 and the metal layer M2. As disposed above, when the monopole antenna is formed of a triple-layer structure, no metal pattern will be printed and no elements will be disposed within the substrate region on which the projection of the radiation body falls.

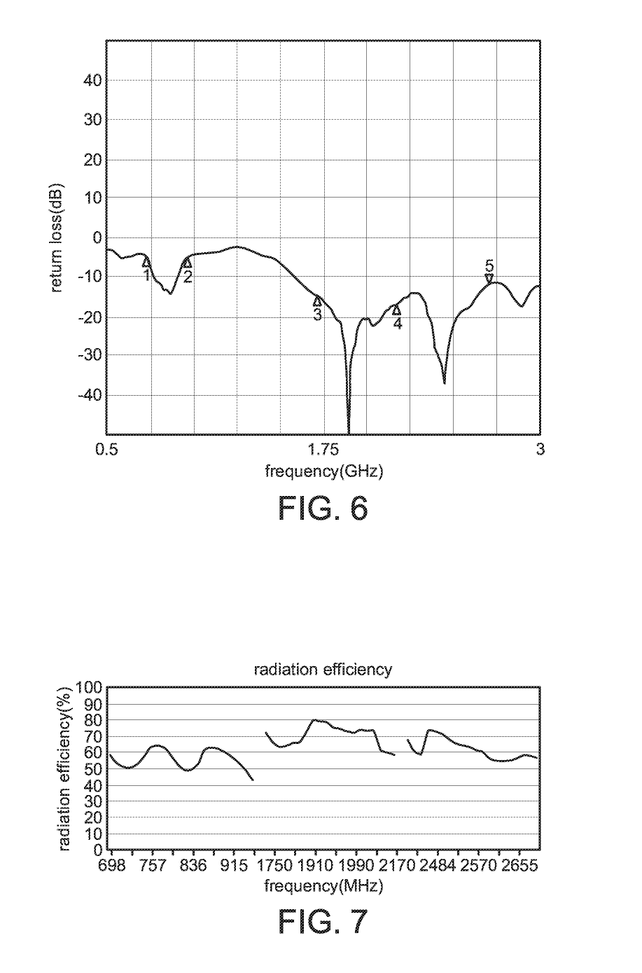

FIG. 6 is a measurement chart of reflection coefficient (S11) of a monopole antenna according to an embodiment of the present invention. As indicated in FIG. 6, the reflection coefficient is under −5 dB when the band is within the range of 724 MHz-960 MHz; the reflection coefficient is under −14 dB when the band is within the range of 1.17 GHz-2.17 GHz; the reflection coefficient is under −12 dB when the band is within the range of 2.17 GHz-2.7 GHz.

FIG. 7 is a simulation chart of radiation efficiency of a monopole antenna according to an embodiment of the present invention. As indicated in FIG. 7, the monopole antenna of the present invention has three operating bands, and each operating band produces excellent radiation efficiency.

To summarize, the monopole antenna disclosed in above embodiments of the present invention not only has independent band adjusting mechanisms, but also provides excellent impedance matching and operating bandwidth. Furthermore, the monopole antenna of the present invention can be independently operated on printed circuit board or operated in collaboration with the system, and can be conveniently used in different systems.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A monopole antenna, which is printed on a substrate and comprises:
a ground plane; and
a radiation body, comprising:
a feeding connection part adjacent to the ground plane;
a first radiation part connecting one side of the feeding connection part and extending along a first direction, wherein the first radiation part is in charge of a first operating frequency of the monopole antenna and comprises:
a metal patch whose width reduces towards the first direction;
a second radiation part connecting the side of the feeding connection part and extending along the first direction, wherein the second radiation part is closer to the ground plane than the first radiation part and is in charge of a second operating frequency of the monopole antenna; and
a third radiation part connecting the other side of the feeding connection part and extending along a second direction inverse to the first direction, wherein the third radiation part is in charge of a third operating frequency of the monopole antenna, the second operating frequency is higher than the third operating frequency, and the third operating frequency is higher than the first operating frequency.

2. The monopole antenna according to claim 1, wherein the feeding connection part, the first radiation part and the third radiation part form a T shape, the first radiation part and the third radiation part are perpendicular to one end of the feeding connection part farther away from the ground plane, and the first radiation part and the third radiation part are inversely disposed by 180°.

3. The monopole antenna according to claim 1, wherein the width of the metal patch gradually reduces towards the first direction in a smooth manner.

4. The monopole antenna according to claim 1, wherein the width of the metal patch gradually reduces towards the first direction in a stepped manner.

5. The monopole antenna according to claim 1, wherein the length of the metal patch is larger than that of the second radiation part.

6. The monopole antenna according to claim 1, wherein the metal patch is adjacent to the side of the feeding connection part but farther away from the terminal end of the first radiation part extending towards the first direction.

7. The monopole antenna according to claim 1, wherein the width of the second radiation part increases towards the first direction.

8. The monopole antenna according to claim 1, wherein a signal feeding region extending towards the second direction is disposed at one end of the feeding connection part adjacent to the ground plane for receiving RF signals.

9. The monopole antenna according to claim 1, wherein the radiation body and the ground plane are disposed on the same side surface of the substrate.

10. The monopole antenna according to claim 1, wherein the radiation body and the ground plane are disposed on two sides surfaces of the substrate respectively.
